(19) United States
(12) Patent Application Publication
(10) Pub. No.: US 2018/0128904 A1
(43) Pub. Date: May 10, 2018

(54) LIDAR SCANNER WITH OPTICAL AMPLIFICATION

(71) Applicant: Uber Technologies, Inc., San Francisco, CA (US)

(72) Inventor: James A. Haslim, Dublin, CA (US)

(21) Appl. No.: 15/345,120

(22) Filed: Nov. 7, 2016

(51) Int. Cl. G01S 7/481; G01S 7/484; G01S 17/06

(52) U.S. Cl. CPC G01S 7/4816; G01S 17/06; G01S 7/484; G01S 7/4813

(57) ABSTRACT

A LiDAR sensor can be provided having a laser, optical circulator, amplifying section, photosensor, and an electronic circuit. The laser can be configured to emit a brief electromagnetic pulse. The optical circulator can be positioned to receive the brief electromagnetic pulse from the laser and direct the brief electromagnetic pulse on an optical path towards an object. The optical circulator can also be configured to receive a reflected pulse from the object caused by the brief electromagnetic pulse. The amplifying section can be positioned to receive the reflected pulse from the optical circulator and be configured to optically amplify the reflected pulse to create an amplified reflected pulse. The photosensor can be positioned to receive the amplified reflected pulse from the amplifying section, and to produce a signal in response to the amplified reflected pulse. Finally, the electronic circuit can be configured to determine an intensity of the reflected pulse and a distance to the object based on a time-of-flight of the electromagnetic pulses.

### BACKGROUND

### Field

The present application relates to optical sensors, and particularly to LiDAR (Light Distance And Ranging) sensors and related devices with optical amplification.

### Description of the Related Art

The process for measuring distance and reflectance values for objects within an environment without touching those objects is of great interest to many industries including autonomous vehicles, surveying, architecture, entertainment (character generated effects for movies and video games), construction, forensic, and geography applications. Historically to collect accurate distance and reflectance measurements one used photogrammetry techniques, but the process for extracting information from stereo imagery is time consuming, expensive, and unreliable in certain circumstances. Advances in Light Detecting and Ranging (LiDAR) technology have enabled practitioners to scan large area surfaces while collecting billions of data points, each with a precise distance and angle within the local (relative) coordinate system. The aggregate of the many data points is referred to as a point cloud data set. Practitioners will subsequently extract objects from the point cloud and then create three dimensional models. Those models are then used in numerous applications. For example, in the context of autonomous vehicles, such models may indicate the presence of a static barrier, a moving object, the road, or other objects. Other uses are also possible.

### SUMMARY

LiDAR, specifically time-of-flight based LiDAR, is a distance range measurement technique in which a brief laser pulse (for example, approximately 1-10 nanoseconds pulse width) is emitted and the reflected light is detected while the time between the emitted pulse and reflected pulse is measured. This time of flight of the laser pulse from the time it is emitted until it is reflected back to the LiDAR instrument corresponds to the distance between the LiDAR sensor and the target surface.

The fraction of light reflected by a diffuse (non-shiny) surface is its reflectance. An estimate of the target surface's reflectance can be calculated from the ratio of reflected light received by the LiDAR sensor to the emitted light, given the measured distance to the target.

The direction of the light emitted by the laser can be scanned with a rotating mirror, allowing measurements through a range of angles allowed by the mirror. Thus, the distance to various objects can be measured over a range of angles. The emitted light can also be redirected along multiple axes, such that a 2-dimensional span of angles can be measured.

Time to digital converters (“TDC”) or time measurement units (“TMU”) can be used to make precise time measurements between two electrical events (like pulse edges associated with the received light) and report that time in a digital electronic format. In some embodiments, a TDC chip can achieve a time measurement precision of 10 picoseconds. A TDC can be used to measure the time of flight of a laser pulse for LiDAR distance measurement. Accounting for the speed of light, a time measurement precision of approximately 10 picoseconds would correspond to a distance measurement precision of approximately 1.5 mm.

Photodetectors

LiDAR sensors typically use some form of optic to collect light reflected from target surfaces and focus this light onto a photodetector receiver for conversion to an electronic signal. Avalanche photodiodes are often a good choice for the photodetector because they convert incident photons to electrical current with a high gain or multiplication factor. Other types of photodiodes can also be used, such as a PN diode, PIN diode, or Schottky diode. Phototransistors could also be used, such as a bipolar junction transistor or a field-effect transistor.

References herein to measuring the strength of a pulse from the photodiode can apply to any electronic technique for determining or estimating the amplitude or the integral of amplitude of the current pulse through the photodiode in response to a pulse of light. This pulse can take the form of any time varying current signal that is distinguishable from the quiescent current state of the photodiode, including whatever DC current and noise currents are present while a laser pulse is not being received. Such electronic techniques can include conversion of the current through the photodiode into a voltage signal to facilitate processing and measurement. Making computations from such pulse strength measurements and using these computations to control bias voltages applied to the photodiode can include the use of various types of processors and interface circuits such as analog to digital converters whose digital interfaces are connected to an embedded processor, microcontroller, DSP, FPGA, or CPLD. Optionally, some embodiments may include interface circuits that provide peak holding of a voltage signal that can subsequently be sampled by an analog to digital converter with likewise connection to its digital interface.

In one embodiment, a LiDAR sensor can be provided having a laser, optical circulator, amplifying section, photosensor, and an electronic circuit. The laser can be configured to emit a brief electromagnetic pulse. The optical circulator can be positioned to receive the brief electromagnetic pulse from the laser and direct the brief electromagnetic pulse on an optical path towards an object. The optical circulator can also be configured to receive a reflected pulse from the object caused by the brief electromagnetic pulse. The amplifying section can be positioned to receive the reflected pulse from the optical circulator and be configured to optically amplify the reflected pulse to create an amplified reflected pulse. The photosensor can be positioned to receive the amplified reflected pulse from the amplifying section, and to produce a signal in response to the amplified reflected pulse. Finally, the electronic circuit can be configured to determine an intensity of the reflected pulse and a distance to the object based on a time-of-flight of the electromagnetic pulses.

In a further embodiment, a method of measuring a distance using a LiDAR sensor can be provided. An electromagnetic pulse can be produced and directed toward an object. A reflected pulse caused by the electromagnetic pulse can then be received from the object, and be optically amplified. The intensity of the reflected pulse can then be determined.

### BRIEF DESCRIPTION OF THE DRAWINGS

These and other features, aspects, and advantages disclosed herein are described below with reference to the drawings of preferred embodiments, which are intended to illustrate and not to limit the application. Additionally, from figure to figure, the same reference numerals have been used to designate the same components of an illustrated embodiment. The following is a brief description of each of the drawings.

FIG. 1 depicts an embodiment position sensing device.

FIG. 2 depicts a schematic diagram of an embodiment LiDAR sensor usable with a position sensing device.

### DETAILED DESCRIPTION

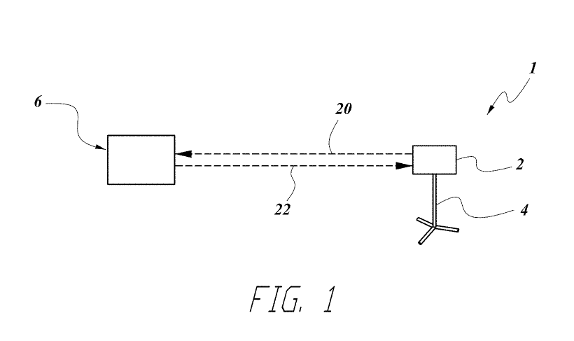

FIG. 1 depicts an embodiment position sensing device 1. The position sensing device is shown in an arbitrary environment including an object 6. It will be understood that the position sensing device 1 can be used in a variety of environments such as a construction site, a mine, a laboratory, on an autonomous vehicle, or other indoor and outdoor environments. The position sensing device 1 can be configured to measure at least one point, or further at least one spatial map of a portion of the environment, such as the object 6. For example, in the context of an autonomous vehicle, the object 6 measured by the position sensing device 1 can be the road or one or more cars on the road. In some embodiments the position sensing device 1 can measure a particular set of separate and discrete points, whereas in further embodiments the position sensing device 1 can measure a continuous span of points, as will be described further below. The measurement can be made using a brief electromagnetic pulse 20 (further described below), such as a light pulse. For example, the pulse 20 can be electromagnetic energy between ultraviolet and far infra-red. Further, the pulse can have a wavelength between 10 nm and 1 mm. However, it will be understood that other mechanisms can be used, such as other pulses along the electromagnetic spectrum and other forms of directional energy. The pulse 20 can be reflected by the object 6 to form an object reflected pulse 22, which can be used by the sensor 2 to determine a position of the object 6 according to a time of arrival of the reflected pulse 22 relative to the time of the initial pulse 20.

As further shown, the position sensing device 1 can include a sensor 2 mounted on a base 4. The base 4 is depicted as a tripod. In some embodiments, it can be desirable to use a base 4 that is substantially stable, as movement of the positioning device 1 during operation can add error to measurements provided by the position sensing device 1. In other embodiments the sensor 2 can be mounted on other objects, such as a vehicle (e.g., car, plane, bicycle), human-carried object (e.g., on a helmet, backpack, or handle), or the like, and other sensors such as accelerometers and GPS (Global Positioning System) devices can be used to measure the movement. Further, it will be understood that the sensor 2 can be usable separate from the base 4 or another mount. For example, some embodiments of the sensor 2 can include a flat bottom such that it can be placed directly on the ground, a table, or another surface. Further embodiments of the sensor 2 can be configured to be held directly by a user.

As noted above, the sensor 2 can be configured to measure a continuous span of points. In some embodiments, this can be best described as an angular span relative to the sensor 2. For example, in some embodiments the sensor 2 can have rotatable elements, such that it can sequentially take measurements over a span of angles. In some embodiments, this span of angles can be defined by a rotation about a single primary axis of rotation 8. As shown in FIG. 1, the axis of rotation 8 can be substantially vertical and aligned with the base 4. The sensor 2 can be configured to rotate about this axis of rotation 8, measuring the distance to one or more objects 6 along the angular span. In further embodiments, the sensor 2 can also measure in angular spans rotating vertically, outside a plane perpendicular to the axis of rotation 8. In embodiments where the sensor 2 can measure along angular spans in both directions, the sensor 2 will potentially be able to measure substantially all objects 6 in its environment, measuring at substantially every combination of angles. However, it will be understood that the angular spans measurable by the sensor 2 may be limited by certain components of the sensor itself which may create blindspots. Nevertheless, in such embodiments substantially all of the environment can still be measured by the sensor 2. Further, in some embodiments the span of rotation allowed for the sensor 2 can be limited to a particular span of interest.

Similarly, in some embodiments the sensor 2 can be a compound sensor with multiple sensor units combined into a single sensor such that a single cycle of the sensor 2 can measure an angular span of points. Examples of this (and other features that can be used with the devices described herein, such as to measure a varying angular span of points) can be seen in U.S. Patent Publication No. 2014/0168631, which is incorporated by reference herein in its entirety.

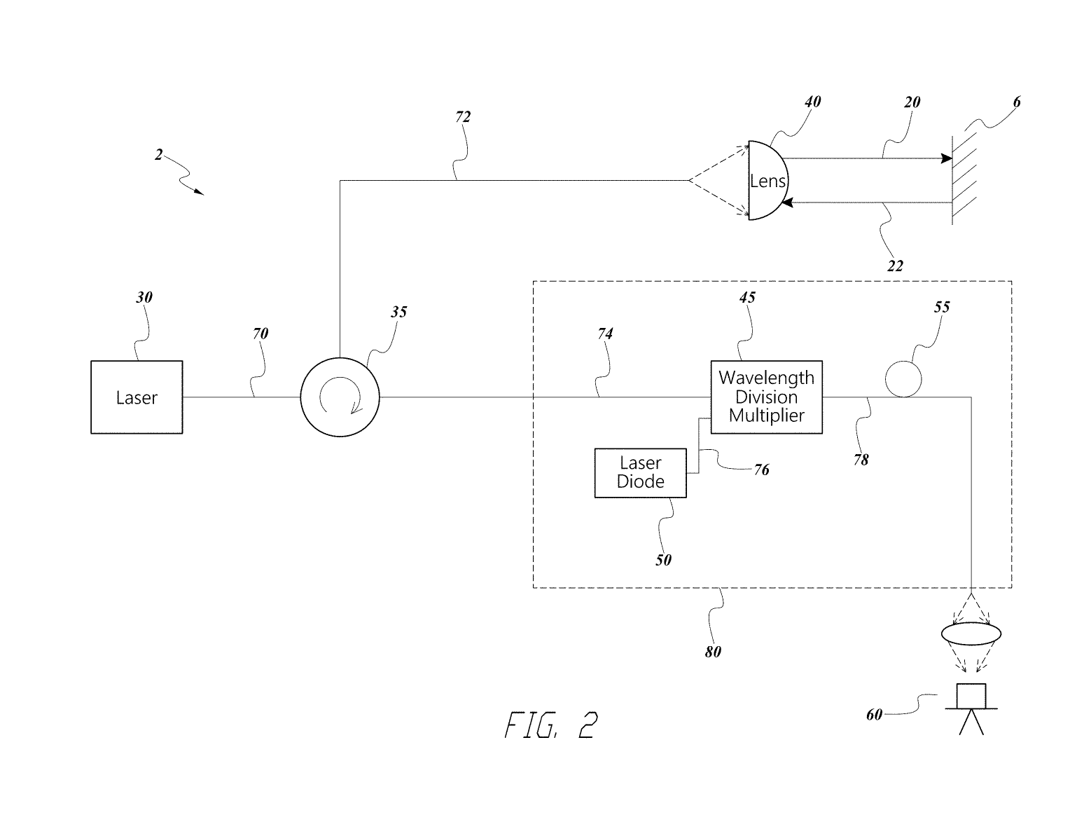

FIG. 2 depicts an embodiment of a sensor 2 configured to measure position. The sensor 2 is depicted as including a fiber laser 30 mounted to the housing 10. The fiber laser 30 can be configured to emit a laser beam, although a wide variety of other forms of energy can be used (as discussed above). The laser beam can be emitted from the fiber laser 30 as a substantially short and discrete pulse of energy. For example, in some embodiments the pulse can have a time-width of less than 20 nanoseconds, less than 15 nanoseconds, less than 10 nanoseconds, less than 5 nanoseconds, or less than 1 nanosecond. The brevity of the pulse can improve the accuracy of the resulting measurement, and thus in some embodiments it can be preferable to maintain a narrow temporal width of the pulse by avoiding components that significantly lengthen the pulse width prior to emitting the pulse into the environment. Further, it may be desirable to maintain the frequency/wavelength of the emitted pulse at a consistent frequency/wavelength that is symmetric in frequency, intensity, or other characteristics to improve the coherency of the measurements by the device. Notably, other types of lasers can be used other than fiber lasers. For example, a diode laser or a q-switched laser could also be used, and their emitted electromagnetic energy can be coupled into optical fiber.

In some embodiments, the emitted pulse from the fiber laser 30 can proceed directly out of the sensor 2, and into the external environment toward the measured object 6. However, in other embodiments it may be desirable to redirect the emitted pulse within the sensor 2 to allow greater flexibility in functionality and packaging of components in the sensor 2. For example, as described in U.S. Patent Publication No. 2016/0306032, incorporated by reference herein in its entirety, the emitted pulse from the fiber laser 30 can be redirected and split prior to exiting the sensor 2. However, as discussed above, the temporal width of the pulse can optionally be maintained.

Referring to FIG. 2, in some embodiments, the light pulse emitted from the laser 30 can be coupled into a fiber optic cable 70. The laser can be a variety of types of laser, such as a fiber laser in which the amplification occurs within optical fiber and whose output is naturally transmitted in an optical fiber, or a solid state laser such as a laser diode that is optically coupled into a fiber optic cable.

As shown in FIG. 2, the laser 30 outputs the emitted pulse to the fiber optic cable 70, which redirects the emitted pulse. The emitted pulse can then enter an optical circulator 35. The optical circulator 35 can be configured to direct light from the optic cable 70 (and the laser 30) to an optic cable 72. The optic cable 72 can then direct the pulse toward the external environment, such as an object 6 to be measured. As shown, optical components 40 such as a lens can be provided along the path between the optic cable 72 and the object 6 to focus the pulse toward the object. As shown and discussed above, the pulse can travel toward the object as an output pulse 20. Prior to this transmission, the pulse can also be split, delayed, or otherwise altered, such as for calibration purposes as discussed in U.S. Patent Publication No. 2016/0306032, incorporated by reference herein in its entirety.

Further, the output pulse 20 can optionally be oriented in a variety of directions. For example, the output pulse can be directed toward a rotating mirror, such that it can be reflected by the mirror in a variety of directions. Alternatively, the cable 72 can be moved such that the direction of a series of output pulses 20 change over time.

The output pulse 20 can then proceed to an external environment and be reflected, as the reflected pulse 22. The reflected pulse 22 can optionally return on a path that generally matches the path taken by the output pulse 20. The path through the environment between the object 6 and the optical components 40 can be substantially the same. Further, the reflected pulse 22 can be received by the sensor through the same optical component (such as a lens 40), so only one lens (or set of lenses) can serve to both focus pulses toward the object and to focus reflected pulses from the object. The reflected pulse 22 can then return into the optical cable 72 and follow the same path back to the circulator 35 taken by the output pulse 20.

However, this overlap in paths for the output and reflected pulses 20, 22 is not necessary. For example, as shown in U.S. Patent Publication No. 2016/0306032, incorporated by reference herein in its entirety, the pulses can take different paths. Further, in some embodiments the cables 70, 72 can be specially configured for the functions required. In the example of FIG. 2, the optical cable 70 from the laser can optionally be a single-mode optical fiber. Further, the optical cable 72 between the optical circulator 35 and the object 6 can be a multi-clad fiber having a core, an inner cladding surrounding the core, and an outer cladding surrounding the inner cladding. The core can be configured to carry the output pulse 20 from the optical circulator 35, thus maintaining a spatially narrower beam. The inner cladding (and optionally also the core) can be configured to carry the reflected pulse 22 back to the optical circulator 35, with the inner cladding surrounding the core and thus providing a larger area to receive the reflected pulse. Further details of such arrangements can be found in U.S. Patent Publication No. 2014/0168631, incorporated by reference herein in its entirety. However, other arrangements and fiber combinations are also possible.

As shown in FIG. 2, the reflected pulse 22 can then be directed by the optical circulator 35 toward an amplification section 80 prior to a photosensor 60, along an optical cable 74. The optical cable 74 can optionally be a multi-mode fiber, although other fiber types are possible. The amplification section 80 can amplify the optical signal received by the sensor 2 prior to reaching the photosensor 60, such that low intensity reflections can still be detected. Thus, objects at long distances and with low reflectances can be detected without needing to increase the strength of the output pulse 20 to levels that are energetically expensive and potentially dangerous.

As shown, the amplification section 80 can serve as an optical amplifier, and can include a pump combiner 45, such as a wavelength division multiplexer (although other types of pump combiner are possible) that receives the reflected pulse 22 from the optical circulator 35. The wavelength division multiplexer 45 can also receive an optical signal from a laser diode 50 along optical fiber 76. The laser diode 50 can act as a pump, or energy source, for the amplification section 80. The wavelength division multiplexer 45 can direct the reflected pulse 22 and light from the laser diode 50 toward an erbium-doped fiber 55, through optical fiber 78. The erbium-doped fiber 55 can use the energy from the laser diode 50 to amplify the reflected pulse 22, and can then direct this amplified optical signal toward a pulse receiving sensor 60, such as a photosensor. Other types of doped fiber can also be used, such as erbium-ytterbium co-doped fiber.

As discussed above, in some embodiments the pulse receiving sensor 60 can include a photodiode such as a PIN diode or an avalanche photodiode. Notably, the amplitude or strength of the signal from the photodiode can depend on the intensity or strength of the electromagnetic pulse received by the photodiode. Similarly, a PIN diode or other photodetectors might be tuned to output a signal that depends on the strength of the light received. However, very low strength pulses may be below a threshold necessary to be detected by the photodiode.

For LiDAR sensors, it is desirable that the threshold level be sufficiently low such that the LiDAR sensor can detect a low-intensity reflected pulse 22. For example, darker objects 6 may reflect a lower intensity pulse. Further, objects 6 far away from the sensor 2 may reflect pulses that are greatly dispersed before they arrive at the sensor 2, causing a lower intensity pulse at the sensor 2. Even further, in hazy conditions the intensity of the reflected pulse may also be reduced.

However, it is also desirable that the threshold level be sufficiently high to prevent false readings. For example, if ambient light is sufficiently strong, it may be possible for the sensor 2 to detect a reflected pulse when no object 6 is actually present. If pulse detection circuitry is tuned to higher sensitivity or electronic noise sources are present, it may be possible for the sensor to similarly detect a reflected pulse when no object 6 is present. An ideal threshold level of pulse intensity is low enough to detect relatively weak pulses, while not so high as to make false readings.

The strength of the signal from the photodiode 60 can also be used to measure the intensity of the received pulse. A stronger intensity reflected pulse 22 will cause a stronger signal from the photodiode. Thus, the strength of the pulse can be estimated from the strength of the signal.

The amplification section 80 can address some of these issues by increasing the strength of the pulse that is received by the photodiode 60. Thus, lower intensity pulses that reach the device 2 can still be detected without choosing an overly sensitive photodiode configuration. However, the amplification section 80 can also substantially maintain a relationship between the incoming and outgoing signals, such that further inferences about the signal strength (and thus the reflectance) of the external object 6 can be made.

Conditional language used herein, such as, among others, “can,” “could,” “might,” “may,” “e.g.,” and from the like, unless specifically stated otherwise, or otherwise understood within the context as used, is generally intended to convey that certain embodiments include, while other embodiments do not include, certain features, elements and/or states. Thus, such conditional language is not generally intended to imply that features, elements and/or states are in any way required for one or more embodiments or that one or more embodiments necessarily include logic for deciding, with or without author input or prompting, whether these features, elements and/or states are included or are to be performed in any particular embodiment.

While the above detailed description has shown, described, and pointed out novel features as applied to various embodiments, it may be understood that various omissions, substitutions, and changes in the form and details of the ground contact sensing system, including the sensor components, logical blocks, modules, and processes illustrated may be made without departing from the spirit of the disclosure. As may be recognized, certain embodiments of the systems described herein may be embodied within a form that does not provide all of the features and benefits set forth herein, as some features may be used or practiced separately from others. Additionally, features described in connection with one embodiment can be incorporated into another of the disclosed embodiments, even if not expressly discussed herein, and the prosthetic device having the combination of features still fall within the scope of the application.

What is claimed is:

1. A LiDAR sensor comprising:
a laser configured to emit a brief electromagnetic pulse;
an optical circulator positioned to receive the brief electromagnetic pulse from the laser and direct the brief electromagnetic pulse on an optical path towards an object, the optical circulator further configured to receive a reflected pulse from the object caused by the brief electromagnetic pulse;
an amplifying section positioned to receive the reflected pulse from the optical circulator and configured to optically amplify the reflected pulse to create an amplified reflected pulse;
a photosensor positioned to receive the amplified reflected pulse from the amplifying section, and to produce a signal in response to the amplified reflected pulse; and
an electronic circuit configured to determine an intensity of the reflected pulse and a distance to the object based on a time-of-flight of the electromagnetic pulses.

2. The LiDAR sensor of claim 1, configured to emit the brief electromagnetic pulse toward the target with a pulse width less than 20 nanoseconds.

3. The LiDAR sensor of claim 2, configured to emit the brief electromagnetic pulse toward the target with a pulse width less than 15 nanoseconds.

4. The LiDAR sensor of claim 3, configured to emit the brief electromagnetic pulse toward the target with a pulse width less than 10 nanoseconds.

5. The LiDAR sensor of claim 4, configured to emit the brief electromagnetic pulse toward the target with a pulse width less than 5 nanoseconds.

6. The LiDAR sensor of claim 5, configured to emit the brief electromagnetic pulse toward the target with a pulse width less than 1 nanosecond.

7. The LiDAR sensor of claim 1, wherein the LiDAR sensor is configured to maintain the pulse width of the brief electromagnetic pulse prior to directing the brief electromagnetic pulse toward the object.

8. The LiDAR sensor of claim 1, wherein the brief electromagnetic pulse directed toward the object is substantially symmetric in frequency.

9. The LiDAR sensor of claim 1, wherein the brief electromagnetic pulse directed toward the object is substantially symmetric in intensity.

10. The LiDAR sensor of claim 1, wherein the brief electromagnetic pulse and the reflected pulse travel between the optical circulator and the object along the same optical path.

11. The LiDAR sensor of claim 1, wherein the amplifying section comprises an erbium-doped fiber.

12. The LiDAR sensor of claim 1, wherein the amplifying section comprises a laser diode.

13. The LiDAR sensor of claim 1, wherein the amplifying section comprises a pump combiner.

14. The LiDAR sensor of claim 1, wherein the photosensor comprises a PIN diode.

15. A method for measuring a distance using a LiDAR sensor, the method comprising:
producing an electromagnetic pulse;
directing the electromagnetic pulse toward an object;
receiving a reflected pulse from the object caused by the electromagnetic pulse;
optically amplifying the reflected pulse; and
determining an intensity of the reflected pulse.

16. The method of claim 15, wherein the electromagnetic pulse is directed toward the object with a pulse width less than 20 nanoseconds.

17. The method of claim 16, wherein the electromagnetic pulse is directed toward the object with a pulse width less than 15 nanoseconds.

18. The method of claim 17, wherein the electromagnetic pulse is directed toward the object with a pulse width less than 10 nanoseconds.

19. The method of claim 18, wherein the electromagnetic pulse is directed toward the object with a pulse width less than 5 nanoseconds.

20. The method of claim 19, wherein the electromagnetic pulse is directed toward the object with a pulse width less than 1 nanosecond.

21. The method of claim 15, further comprising maintaining the pulse width of the electromagnetic pulse prior to directing the electromagnetic pulse toward the object.

22. The method of claim 15, wherein the brief electromagnetic pulse directed toward the object is substantially symmetric in frequency.

23. The method of claim 15, wherein the brief electromagnetic pulse directed toward the object is substantially symmetric in intensity.
